(19) United States
(12) Patent Application Publication
(10) Pub. No.: US 2007/0266513 A1
(43) Pub. Date: Nov. 22, 2007

(54) DUAL MODE PAINT ROLLER

(76) Inventor: Nicholas R. Halker, Lockport, NY (US)

Correspondence Address: JAECKLE FLEISCHMANN & MUGEL, LLP, 190 Linden Oaks, ROCHESTER, NY, 14625-2812, US

(21) Appl. No.: 11/419,050

(22) Filed: May 18, 2006

(51) Int. Cl. B05C 17/02

(52) U.S. Cl. 15/230.11

(57) ABSTRACT

A paint roller frame has left and right bent wire connectors between the handle and the paint roller support to apply paint evenly to a surface and to more easily transfer paint from a paint tray to the paint roller. The right bent wire connector can be separated from the paint roller support and rotated until it is against the left paint roller support to facilitate painting in a corner with the paint roller.

### TECHNICAL FIELD

The present invention relates to paint rollers, and more particularly, to dual mode paint rollers.

### BACKGROUND OF THE INVENTION

Common paint rollers have a paint roller frame and a hollow cylindrical roller that is slipped onto the frame. In order to allow the paint roller to work near a corner the frame consists of a handle, a paint roller support, and a single bent wire attachment between the handle and one end of the paint roller support. However this single bent wire attachment, since it only connects to one end of the cylindrical frame, results in uneven pressure applied by the roller to the surface being painted.

Paint rollers with two bent wire connection pieces are known in the art as shown, for example, in U.S. Pat. Nos. 5,509,165, 3,714,674, and 3,604,046, and in UK patent application 2 410 910. However, these patents and application show double bent wire connections that do not allow the paint roller to paint as close to a corner as a conventional paint roller frame.

What is needed is paint roller frame that provides the advantages of double bent wire connections without interfering with the use of the paint roller in corners.

### SUMMARY OF THE INVENTION

Briefly described in one embodiment of the present invention, a paint roller frame has right and left bent wire connectors wherein the right bent wire connector can be rotated toward the left bent wire connector.

### BRIEF DESCRIPTION OF THE DRAWINGS

The accompanying drawings which are incorporated into and form a part of the specification, illustrate the preferred embodiment of the present invention and, together with the description, serve to explain the principles of the invention. The drawings are only for the purpose of illustrating a preferred embodiment of the invention and are not to be construed as limiting the invention.

FIG. 1 is a front view of a paint roller according to one embodiment of the present invention;

FIG. 2 is a front view of the paint roller shown in FIG. 1 with the right bent wire connector held away from the right edge of the paint roller;

FIG. 3 is a cross sectional view taken from FIG. 2;

FIG. 4 is a cross sectional view of the right side of the paint roller support of the paint roller frame shown in FIG. 1;

FIG. 5 is a view of part of the front of the paint roller handle shown in FIG. 1 with a portion of the handle cut away to show the structure used to hold the right hand bent wire connector in the handle of the paint roller frame;

FIG. 6 is a front view of an alternative embodiment of the paint roller frame according to the present invention;

FIG. 7 is a partial cross sectional view of the top of an alternative to the handle shown in FIG. 1;

FIGS. 8A, 8B, and 8C shown an alternative embodiment of a paint roller according to the present invention with a rotatable bent wire connector shown in three different positions; and

FIGS. 9A, 9B, and 9C are cross sectional views taken from FIGS. 8A, 8B, and 8C, respectively.

It will be appreciated that for purposes of clarity and where deemed appropriate, reference numerals have been repeated in the figures to indicate corresponding features, and that the various elements in the drawings have not necessarily been drawn to scale in order to better show the features of the invention.

### DESCRIPTION OF THE PREFERRED EMBODIMENTS

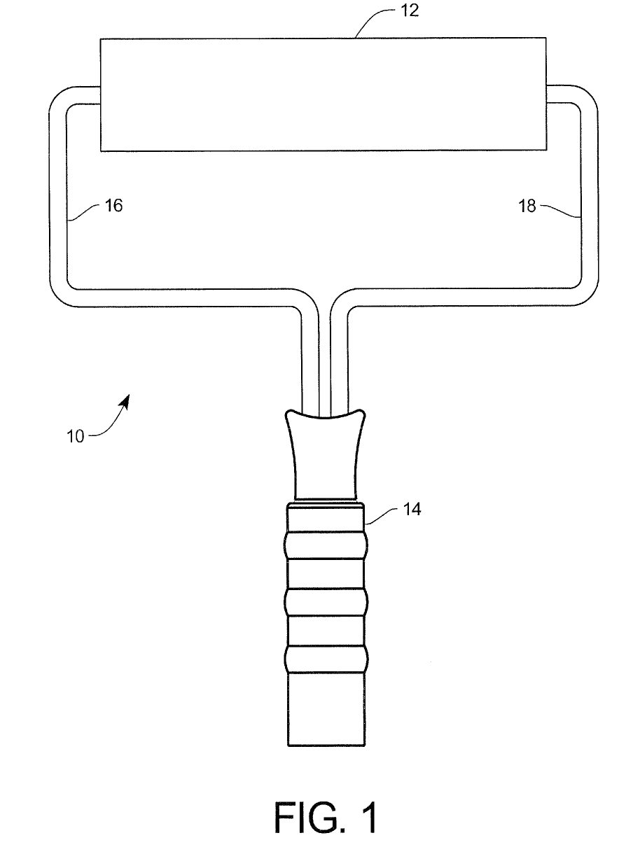

FIG. 1 is a front view of a paint roller frame 10 according to one embodiment of the present invention with a roller cover 12 mounted on the paint roller support 30 of the frame 10. The frame 10 has a handle 14 with a left bent wire connector 16 rigidly attached to the handle 14, and a right bent wire connector 18 rotatably attached to the handle 14.

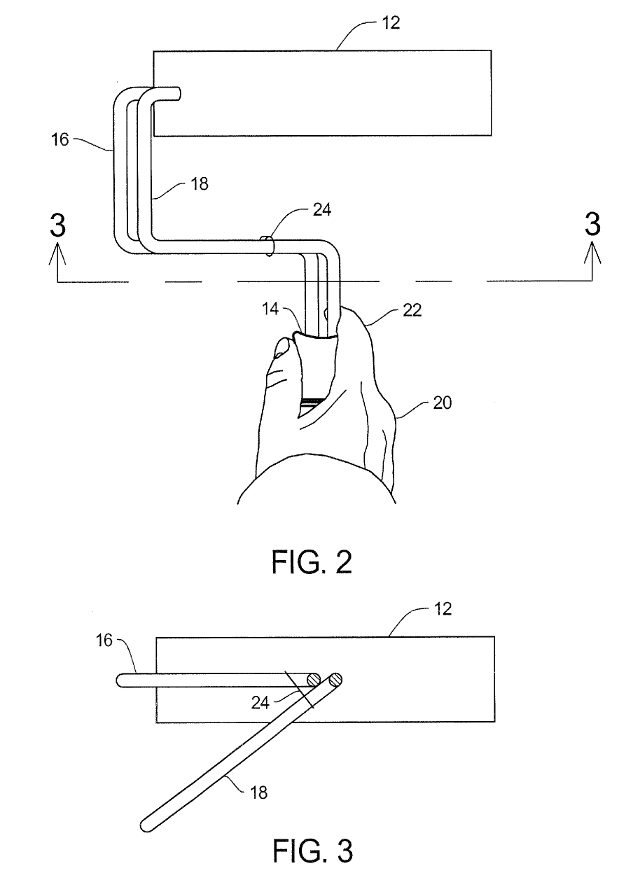

FIG. 2 is a front view of the paint roller frame 10 shown in FIG. 1 with the right bent wire connector 18 held away from the right edge of the roller cover 12. The right bent wire connector 18 is pulled latterly away from the left bent wire connector 16 enough for the right bent wire connector 18 to clear the roller cover 12 and then rotated until it makes contact with the left bent wire connector 16. A hand 20 of a user has an index finger 22 held against the right bent wire connector 18 to keep the right bent wire connector 18 from moving relative to the left bent wire connector 16 when painting in corners. In an alternative embodiment, a clip 24 mounted on the right bent wire connector 18 can be used to hold the right and left bent wire connectors together while painting in corners.

With the right bent wire connector 18 rotated next to the left bent wire connector 16 the right edge of the roller cover 12 can paint close to or into a corner. When the roller cover 12 is not in a corner, the right bent wire connector 18 is put in the position shown in FIG. 1 in order to gain the advantages of having bent wire connectors at each end of the paint roller support 30 of the paint roller frame 10.

FIG. 3 is a cross sectional view taken from FIG. 2 showing the horizontal position of the left and right bent wire connectors 16 and 18, respectively, when the right bent wire connector 18 is against the left bent wire connector 16.

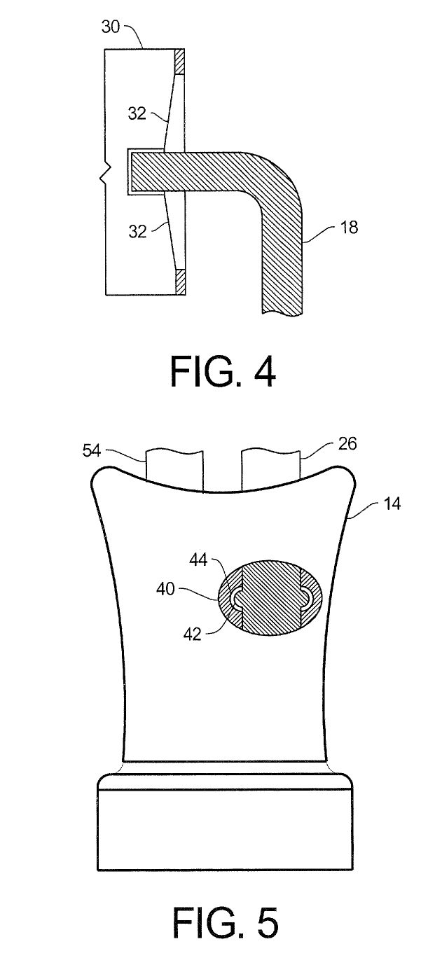

FIG. 4 is a cross sectional view of the portion of the paint roller frame 10 that is the right end of the support 30 for the roller cover 12. The right end 30 has a tapered surface 32 to allow the left bent wire connector 18 to be easily placed back onto the center of the paint roller support 30.

FIG. 5 is a view of part of the front of the paint roller handle 14 shown in FIG. 1 with a portion 40 cut away to show the structure used to hold the right hand bent wire connector 18 in the handle 14 of the paint roller frame 10 in one embodiment of the invention. The portion of the right bent wire connector 18 inserted into the handle 14 has a ridge 42 formed in it that fits into a groove 44 formed in the handle 14, so that when the paint roller frame 10 is assembled, the right bent wire connector 18 is pressed into the opening on the top of the handle 14, until the ridge 42 comes to rest inside the groove 42 and thus prevents the right bent wire connector 18 from becoming separated from the handle 14 when the paint roller frame 10 is being used.

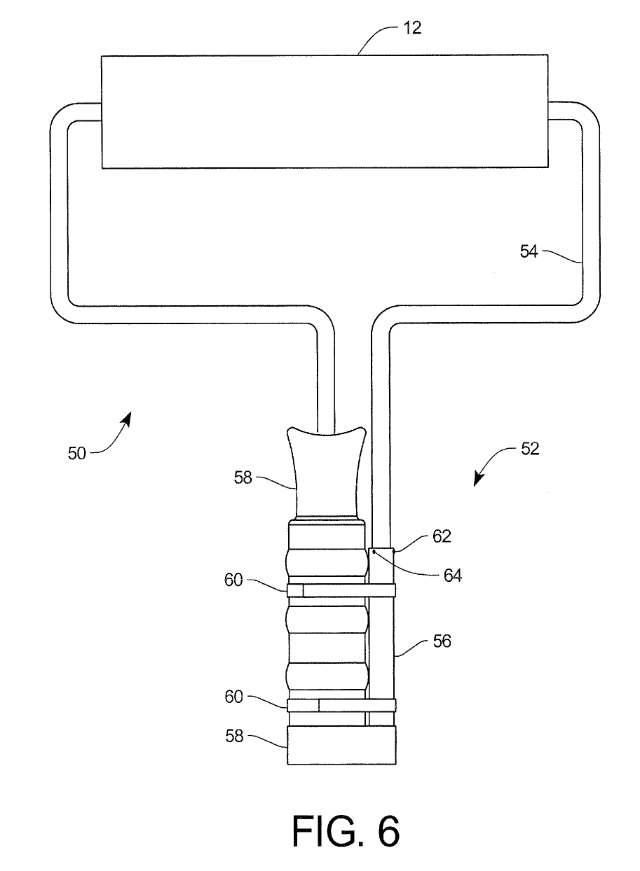

FIG. 6 is a front view of an alternative paint roller frame 50 according to the present invention in which an adapter 52 is attached to the conventional paint roller frame 50. The right end of the paint roller support 30 of the paint roller frame 50 has had a hole drilled into it to accept the right bent wire connector 54. The right bent wire connector 54 sits in a casing 56 such that the right bent wire connector 54 is free to rotate inside the casing 56. The casing 56 is secured to the handle 58 of the paint roller frame 52 by a bottom sleeve 58 and by two flexible bands 60 which fit around the handle 58.

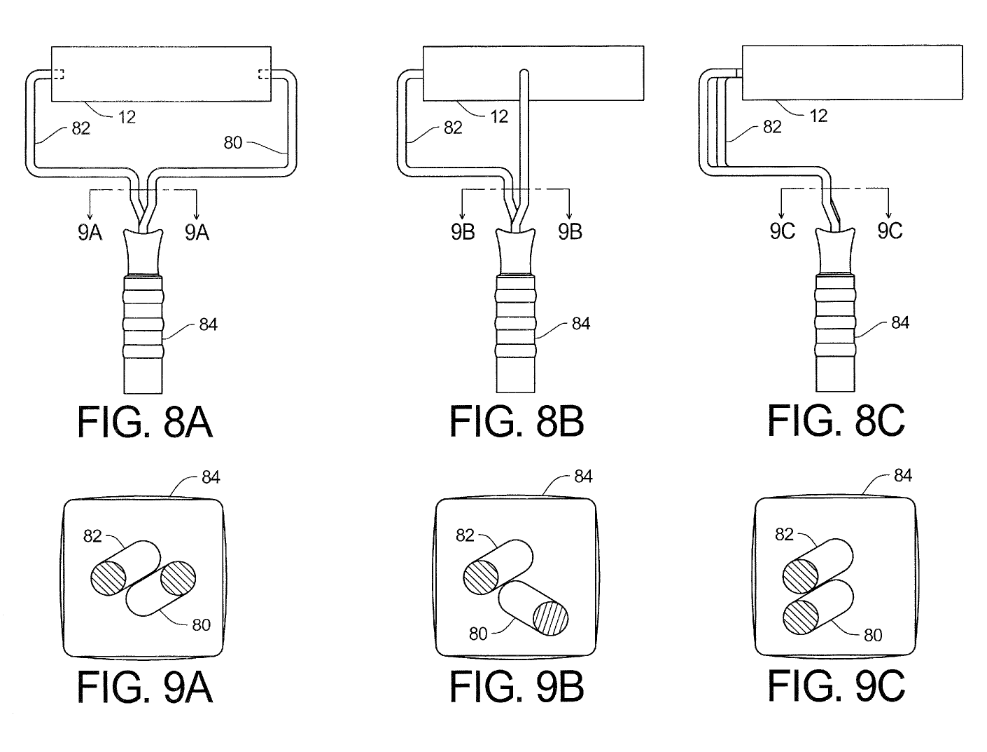

In an alternative embodiment of the invention the casing 56 has two dimples 62 and 64 which receive a dimple on the right bent wire connector 54 (shown in FIG. 8). The dimple in the right bent wire connector 54 is in contact with the dimple 64 in the casing 56 when the right bent wire connector 54 is inserted in the paint roller holder 30 to help prevent twisting of the roller cover 12, and is in contact with the dimple 64 when the right bent wire connector 54 is rotated to the left to hold the right bent wire connector 54 from swinging when a corner area is being painted.

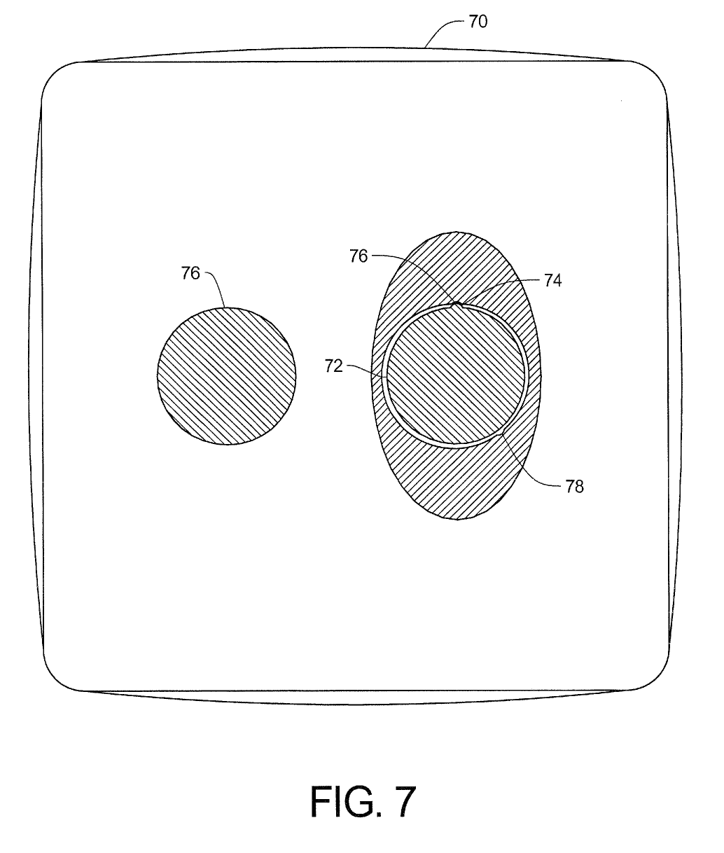

FIG. 7 is a partial cross sectional view of the top of an alternative to the handle shown in FIG. 1. The left bent wire connector 16, shown in cross section, is secured to the alternate handle 70. A right bent wire connector 72, also shown in cross section, has a dimple 74 which comes in contact with one of two dimples 76 and 78 in the handle 70. The dimple 74 is in contact with the dimple 76 when the right bent wire connector 72 is inserted in the paint roller holder 30 to help prevent the twisting of the roller cover 12, and is in contact with the dimple 78 when the right bent wire connector 72 is rotated to the left to hold the right bent wire connector 72 from swinging when a corner area is being painted.

FIGS. 8A, 8B, and 8C are front views of an alternative embodiment of a paint roller shown in FIG. 1 showing a right rotatable bent wire connector 80 in three different positions. A left bent wire connector 82 and the rotatable right bent wire connector 80 are held in a handle 84 which is a little to the left of the center of the roller cover 12. The left and right bent wire connectors 82 and 80, respectively, are shaped such that when the right bent wire connector 80 is swung fully to the left, it lays essentially flat against the left bent wire connector 82.

FIGS. 9A, 9B, and 9C are cross sectional views taken from FIGS. 8A, 8B, and 8C, respectively.

The dual mode paint roller of the present invention allows even pressure across the roller cover 12 during painting and also allows the user to apply greater pressure to the roller cover 12 thereby allowing the user to more quickly apply the paint. The even pressure and second bent wire connector essentially prevents the roller cover 12 from inadvertently sliding off the paint roller holder 30. Also, more paint can be transferred from the roller cover 12 to the surface being painted by the use of the increased pressure, and the number of times that the roller cover 12 must be put in a paint tray is reduced. The increased even pressure and increased pressure is more evident when an extension pole is being used.

The rotating right bent wire connector not only allows the user to paint in a corner by simply detaching the right bent wire connector from the paint roller holder 30 and rotating the connector away from the end of the roller cover 12, but also allows easy changing of the roller cover 12.

The embodiments described are to provide an illustration of principles of the invention and its practical application to enable thereby one of ordinary skill in the art to utilize the invention in various embodiments and with various modifications as are suitable to the particular use contemplated. Therefore, the foregoing description is to be considered exemplary, rather than limiting, and the true scope of the invention is that described in the following claims.

What is claimed is:

1. A paint roller frame having right and left bent wire connectors wherein said right bent wire connector can be rotated toward said left bent wire connector.

2. The paint roller frame according to claim 1 wherein said left bent wire connector is fixed to a handle of said paint roller frame and said right bent wire connector is attached to said handle in a manner to allow said right bent wire connector to rotate.

3. The paint roller frame according to claim 1 wherein said left bent wire connector is fixed to a handle of said paint roller frame and one end of said right bent wire connector is in a casing that is attached to said handle.

4. The paint roller frame according to claim 1 further including a clip to hold said right and left bent frame connectors together.

5. The paint roller frame according to claim 2 wherein said handle has a groove in a opening for said right bent wire connector in said handle and said right bent wire connector has a ridge that fits in said groove.

6. The paint roller frame according to claim 1 wherein a paint roller support portion of said paint roller frame has a tapered surface in one end thereof to facilitate the insertion of an end of said right bent wire connector.

7. The paint roller frame according to claim 1 wherein said right bent wire connector has a dimple that is adapted to contact a mating dimple in a holder of said right bent wire connector to restrict the rotational movement of said right bent wire connector.

8. The paint roller frame according to claim 1 wherein said right and left hand bent wire connectors are shaped such that said right and left hand connectors can lay substantially flat against each other.
